(19) United States
(12) Patent Application Publication
(10) Pub. No.: US 2026/0154430 A1
(43) Pub. Date: Jun. 4, 2026

(54) MEMORY PRESERVED WARM RESET MECHANSIM

(71) Applicant: Intel Corporation, Santa Clara, CA (US)

(72) Inventors: Jiewen Yao, Shanghai (CN); Murugasamy Nachimuthu, Beaverton, OR (US)

(73) Assignee: Intel Corporation, Santa Clara, CA (US)

(21) Appl. No.: 18/880,728

(22) PCT Filed: Aug. 25, 2022
(86) PCT No.: PCT/CN2022/114779

§ 371 Date: Jan. 2, 2025

(51) Int. Cl. G06F 21/62

(52) U.S. Cl. CPC G06F 21/6218

(57) ABSTRACT

An apparatus is disclosed. The apparatus comprises one or more processors to receive a request to trigger a system management interrupt (SMI), execute policy shim code to enforce access control policy in a first privilege level and dispatch the SMI to shield code to enforce the access security policy to perform a system management mode (SMM) and execute the shield code to perform the SMM, including retrieving an operating system (OS) memory preserved warm reset (MPWR) context, saving the context and issuing a warm reset.

### BACKGROUND OF THE DESCRIPTION

In server computer system platforms, platform firmware (e.g., Basic Input/Output System (BIOS)/Microcode) upgrades often requires a system reset. Since a system reset results in the interruption of service, the reset time must remain as short as possible. Memory preserved warm reset (MPWR) is implemented to preserve operating system (OS) memory and activate upgraded firmware to mitigate the interruption of service during a reset.

### BRIEF DESCRIPTION OF THE DRAWINGS

So that the manner in which the above recited features of the present embodiment can be understood in detail, a more particular description of the embodiment, briefly summarized above, may be had by reference to embodiments, some of which are illustrated in the appended drawings. It is to be noted, however, that the appended drawings illustrate only typical embodiments of this embodiment and are therefore not to be considered limiting of its scope, for the embodiment may admit to other equally effective embodiments.

FIG. 1 is a simplified block diagram of at least one embodiment of a computing device for secure I/O with an accelerator device;

FIG. 2 is a simplified block diagram of at least one embodiment of an accelerator device of the computing device of FIG. 1;

FIG. 3 is a simplified block diagram of at least one embodiment of an environment of the computing device of FIGS. 1 and 2;

FIG. 4 illustrates a computing device according to implementations of the disclosure;

FIG. 5 illustrates one embodiment of a platform.

FIG. 6 illustrates an exemplary MPWR architecture.

FIG. 7 illustrates one embodiment of a MPWR architecture;

FIGS. 8A&8B is a flow diagram illustrating one embodiment of a MPWR process.

FIGS. 9A-9C is a flow diagram illustrating another embodiment of a MPWR process.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

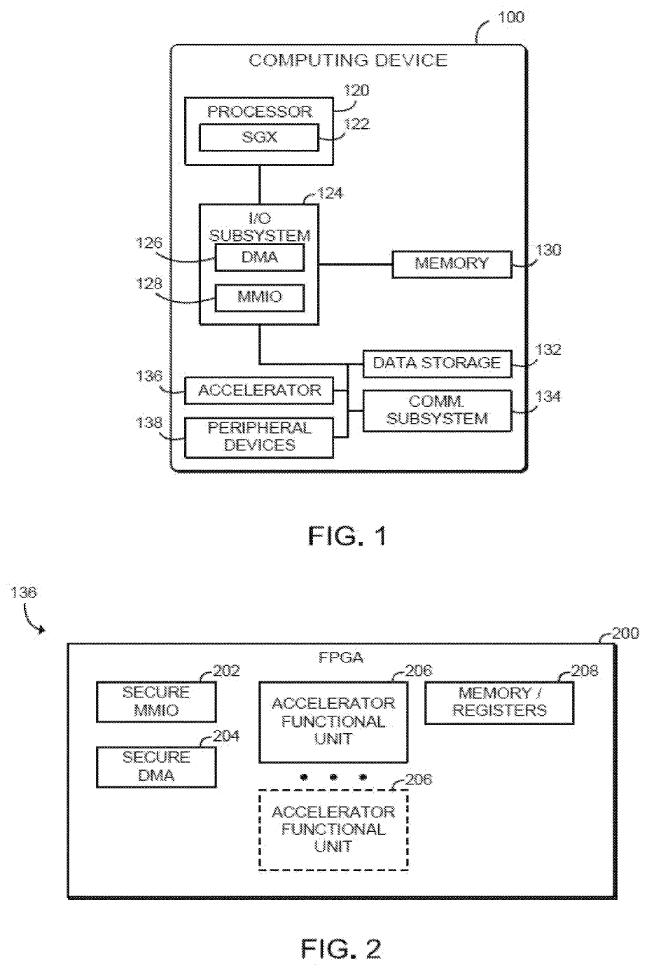

Referring now to FIG. 1, a computing device 100 for secure I/O with an accelerator device includes a processor 120 and an accelerator device 136, such as a field-programmable gate array (FPGA). In use, as described further below, a trusted execution environment (TEE) established by the processor 120 securely communicates data with the accelerator 136. Data may be transferred using memory-mapped I/O (MMIO) transactions or direct memory access (DMA) transactions. For example, the TEE may perform an MMIO write transaction that includes encrypted data, and the accelerator 136 decrypts the data and performs the write. As another example, the TEE may perform an MMIO read request transaction, and the accelerator 136 may read the requested data, encrypt the data, and perform an MMIO read response transaction that includes the encrypted data. As yet another example, the TEE may configure the accelerator 136 to perform a DMA operation, and the accelerator 136 performs a memory transfer, performs a cryptographic operation (i.e., encryption or decryption), and forwards the result. As described further below, the TEE and the accelerator 136 generate authentication tags (ATs) for the transferred data and may use those ATs to validate the transactions. The computing device 100 may thus keep untrusted software of the computing device 100, such as the operating system or virtual machine monitor, outside of the trusted code base (TCB) of the TEE and the accelerator 136. Thus, the computing device 100 may secure data exchanged or otherwise processed by a TEE and an accelerator 136 from an owner of the computing device 100 (e.g., a cloud service provider) or other tenants of the computing device 100. Accordingly, the computing device 100 may improve security and performance for multi-tenant environments by allowing secure use of accelerator devices. As used herein, a TCB comprises a set the set of all hardware, firmware, and/or software components within a computer system that are critical to the system's security.

The computing device 100 may be embodied as any type of device capable of performing the functions described herein. For example, the computing device 100 may be embodied as, without limitation, a computer, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 100 includes a processor 120, an I/O subsystem 124, a memory 130, and a data storage device 132.

Additionally, in some embodiments, one or more of the illustrative components may be incorporated in, or otherwise form a portion of, another component. For example, the memory 130, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes secure enclave support 122, which allows the processor 120 to establish a trusted execution environment known as a secure enclave, in which executing code may be measured, verified, and/or otherwise determined to be authentic.

Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 130. The secure enclave support 122 may be embodied as a set of processor instruction extensions that allows the processor 120 to establish one or more secure enclaves in the memory 130. For example, the secure enclave support 122 may be embodied as Intel® Software Guard Extensions (SGX) technology. In other embodiments, the secure enclave support 122 may be utilized by Intel® Trusted Domain Extensions (TDX) technology that is implemented to isolate virtual machines from the virtual machine monitor and other virtual machines operating on the computing device 100.

The memory 130 may be embodied as any type of volatile or non-volatile memory or data storage capable of performing the functions described herein. In operation, the memory 130 may store various data and software used during operation of the computing device 100 such as operating systems, applications, programs, libraries, and drivers. As shown, the memory 130 may be communicatively coupled to the processor 120 via the I/O subsystem 124, which may be embodied as circuitry and/or components to facilitate input/output operations with the processor 120, the memory 130, and other components of the computing device 100. For example, the I/O subsystem 124 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 130 may be directly coupled to the processor 120, for example via an integrated memory controller hub. Additionally, in some embodiments, the I/O subsystem 124 may form a portion of a system-on-a-chip (SoC) and be incorporated, along with the processor 120, the memory 130, the accelerator device 136, and/or other components of the computing device 100, on a single integrated circuit chip. Additionally, or alternatively, in some embodiments the processor 120 may include an integrated memory controller and a system agent, which may be embodied as a logic block in which data traffic from processor cores and I/O devices converges before being sent to the memory 130.

As shown, the I/O subsystem 124 includes a direct memory access (DMA) engine 126 and a memory-mapped I/O (MMIO) engine 128. The processor 120, including secure enclaves established with the secure enclave support 122, may communicate with the accelerator device 136 with one or more DMA transactions using the DMA engine 126 and/or with one or more MMIO transactions using the MMIO engine 128. The computing device 100 may include multiple DMA engines 126 and/or MMIO engines 128 for handling DMA and MMIO read/write transactions based on bandwidth between the processor 120 and the accelerator 136. Although illustrated as being included in the I/O subsystem 124, it should be understood that in some embodiments the DMA engine 126 and/or the MMIO engine 128 may be included in other components of the computing device 100 (e.g., the processor 120, memory controller, or system agent), or in some embodiments may be embodied as separate components.

The data storage device 132 may be embodied as any type of device or devices configured for short-term or long-term storage of data such as, for example, memory devices and circuits, memory cards, hard disk drives, solid-state drives, non-volatile flash memory, or other data storage devices. The computing device 100 may also include a communications subsystem 134, which may be embodied as any communication circuit, device, or collection thereof, capable of enabling communications between the computing device 100 and other remote devices over a computer network (not shown). The communications subsystem 134 may be configured to use any one or more communication technology (e.g., wired or wireless communications) and associated protocols (e.g., Ethernet, Bluetooth®, Wi-Fi®, WiMAX, 3G, 4G LTE, etc.) to affect such communication.

The accelerator device 136 may be embodied as a field-programmable gate array (FPGA), an application-specific integrated circuit (ASIC), a coprocessor, or other digital logic device capable of performing accelerated functions (e.g., accelerated application functions, accelerated network functions, or other accelerated functions), GPUs, etc. Illustratively, the accelerator device 136 is an FPGA, which may be embodied as an integrated circuit including programmable digital logic resources that may be configured after manufacture. The FPGA may include, for example, a configurable array of logic blocks in communication over a configurable data interchange. The accelerator device 136 may be coupled to the processor 120 via a high-speed connection interface such as a peripheral bus (e.g., a PCI Express bus) or an inter-processor interconnect (e.g., an in-die interconnect (IDI) or QuickPath Interconnect (QPI)), or via any other appropriate interconnect. The accelerator device 136 may receive data and/or commands for processing from the processor 120 and return results data to the processor 120 via DMA, MMIO, or other data transfer transactions.

As shown, the computing device 100 may further include one or more peripheral devices 138. The peripheral devices 138 may include any number of additional input/output devices, interface devices, hardware accelerators, and/or other peripheral devices. For example, in some embodiments, the peripheral devices 138 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The computing device 100 may also include a network interface controller (NIC) 150. NIC 150 enables computing device 100 to communicate with another computing device 100 via a network. In embodiments, NIC 150 may comprise a programmable (or smart) NIC, infrastructure processing unit (IPU), or datacenter processing unit (DPU) that may be configured to perform different actions based on a type of packet, connection, or other packet characteristic.

Referring now to FIG. 2, an illustrative embodiment of a field-programmable gate array (FPGA) 200 is shown. As shown, the FPGA 200 is one potential embodiment of an accelerator device 136. The illustratively FPGA 200 includes a secure MMIO engine 202, a secure DMA engine 204, one or more accelerator functional units (AFUs) 206, and memory/registers 208. As described further below, the secure MMIO engine 202 and the secure DMA engine 204 perform in-line authenticated cryptographic operations on data transferred between the processor 120 (e.g., a secure enclave established by the processor) and the FPGA 200 (e.g., one or more AFUs 206). In some embodiments, the secure MMIO engine 202 and/or the secure DMA engine 204 may intercept, filter, or otherwise process data traffic on one or more cache-coherent interconnects, internal buses, or other interconnects of the FPGA 200.

Each AFU 206 may be embodied as logic resources of the FPGA 200 that are configured to perform an acceleration task. Each AFU 206 may be associated with an application executed by the computing device 100 in a secure enclave or other trusted execution environment. Each AFU 206 may be configured or otherwise supplied by a tenant or other user of the computing device 100. For example, each AFU 206 may correspond to a bitstream image programmed to the FPGA 200. As described further below, data processed by each AFU 206, including data exchanged with the trusted execution environment, may be cryptographically protected from untrusted components of the computing device 100 (e.g., protected from software outside of the trusted code base of the tenant enclave). Each AFU 206 may access or otherwise process stored in the memory/registers 208, which may be embodied as internal registers, cache, SRAM, storage, or other memory of the FPGA 200. In some embodiments, the memory 208 may also include external DRAM or other dedicated memory coupled to the FPGA 200.

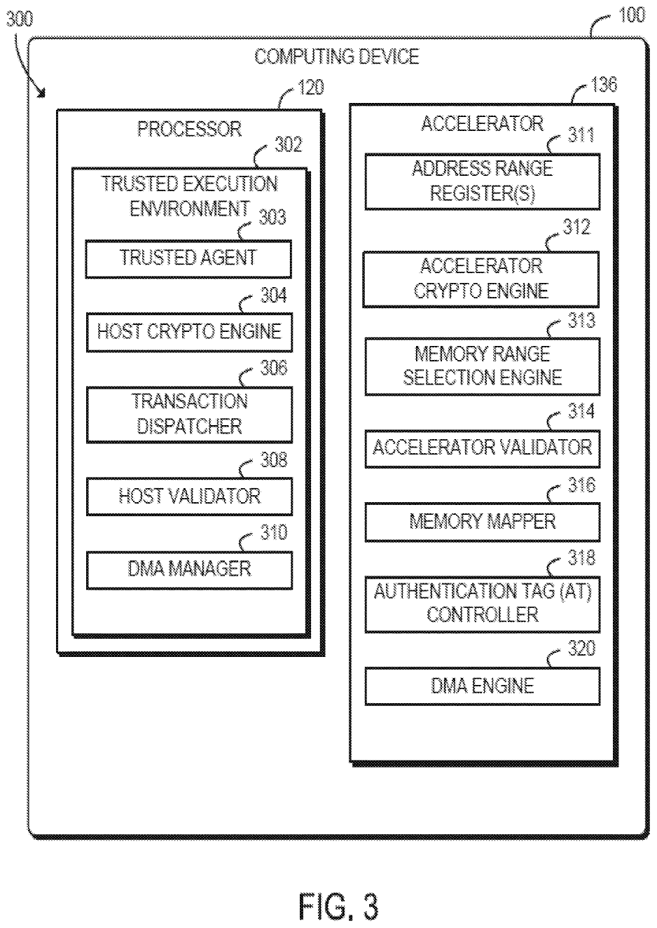

Referring now to FIG. 3, in an illustrative embodiment, the computing device 100 establishes an environment 300 during operation. The illustrative environment 300 includes a trusted execution environment (TEE) 302 and the accelerator 136. The TEE 302 further includes a trusted agent 303, host cryptographic engine 304, a transaction dispatcher 306, a host validator 308, and a direct memory access (DMA) manager 310. The accelerator 136 includes an accelerator cryptographic engine 312, a memory range selection engine 313, an accelerator validator 314, a memory mapper 316, an authentication tag (AT) controller 318, and a DMA engine 320. The various components of the environment 300 may be embodied as hardware, firmware, software, or a combination thereof. As such, in some embodiments, one or more of the components of the environment 300 may be embodied as circuitry or collection of electrical devices (e.g., host cryptographic engine circuitry 304, transaction dispatcher circuitry 306, host validator circuitry 308, DMA manager circuitry 310, accelerator cryptographic engine circuitry 312, accelerator validator circuitry 314, memory mapper circuitry 316, AT controller circuitry 318, and/or DMA engine circuitry 320). It should be appreciated that, in such embodiments, one or more of the host cryptographic engine circuitry 304, the transaction dispatcher circuitry 306, the host validator circuitry 308, the DMA manager circuitry 310, the accelerator cryptographic engine circuitry 312, the accelerator validator circuitry 314, the memory mapper circuitry 316, the AT controller circuitry 318, and/or the DMA engine circuitry 320 may form a portion of the processor 120, the I/O subsystem 124, the accelerator 136, and/or other components of the computing device 100. Additionally, in some embodiments, one or more of the illustrative components may form a portion of another component and/or one or more of the illustrative components may be independent of one another.

The TEE 302 may be embodied as a trusted execution environment of the computing device 100 that is authenticated and protected from unauthorized access using hardware support of the computing device 100, such as the secure enclave support 122 of the processor 120. Illustratively, the TEE 302 may be embodied as one or more secure enclaves established using Intel SGX technology and utilized by TDX technology. The TEE 302 may also include or otherwise interface with one or more drivers, libraries, or other components of the computing device 100 to interface with the accelerator 136.

The host cryptographic engine 304 is configured to generate an authentication tag (AT) based on a memory-mapped I/O (MMIO) transaction and to write that AT to an AT register of the accelerator 136. For an MMIO write request, the host cryptographic engine 304 is further configured to encrypt a data item to generate an encrypted data item, and the AT is generated in response to encrypting the data item. For an MMIO read request, the AT is generated based on an address associated with MMIO read request.

The transaction dispatcher 306 is configured to dispatch the memory-mapped I/O transaction (e.g., an MMIO write request or an MMIO read request) to the accelerator 136 after writing the calculated AT to the AT register. An MMIO write request may be dispatched with the encrypted data item.

The host validator 308 may be configured to verify that an MMIO write request succeeded in response dispatching the MMIO write request. Verifying that the MMIO write request succeeded may include securely reading a status register of the accelerator 136, securely reading a value at the address of the MMIO write from the accelerator 136, or reading an AT register of the accelerator 136 that returns an AT value calculated by the accelerator 136, as described below. For MMIO read requests, the host validator 308 may be further configured to generate an AT based on an encrypted data item included in a MMIO read response dispatched from the accelerator 136; read a reported AT from a register of the accelerator 136; and determine whether the AT generated by the TEE 302 matches the AT reported by the accelerator 136. The host validator 308 may be further configured to indicate an error if those ATs do not match, which provides assurance that data was not modified on the way from the TEE 302 to the accelerator 136.

The accelerator cryptographic engine 312 is configured to perform a cryptographic operation associated with the MMIO transaction and to generate an AT based on the MMIO transaction in response to the MMIO transaction being dispatched.

For an MMIO write request, the cryptographic operation includes decrypting an encrypted data item received from the TEE 302 to generate a data item, and the AT is generated based on the encrypted data item. For an MMIO read request, the cryptographic operation includes encrypting a data item from a memory of the accelerator 136 to generate an encrypted data item, and the AT is generated based on that encrypted data item.

The accelerator validator 314 is configured to determine whether the AT written by the TEE 302 matches the AT determined by the accelerator 136. The accelerator validator 314 is further configured to drop the MMIO transaction if those ATs do not match. For MMIO read requests, the accelerator validator 314 may be configured to generate a poisoned AT in response to dropping the MMIO read request, and may be further configured to dispatch a MMIO read response with a poisoned data item to the TEE 302 in response to dropping the MMIO read request.

The memory mapper 316 is configured to commit the MMIO transaction in response to determining that the AT written by the TEE 302 matches the AT generated by the accelerator 136. For an MMIO write request, committing the transaction may include storing the data item in a memory of the accelerator 136. The memory mapper 316 may be further configured to set a status register to indicate success in response to storing the data item. For an MMIO read request, committing the transaction may include reading the data item at the address in the memory of the accelerator 136 and dispatching an MMIO read response with the encrypted data item to the TEE 302.

The DMA manager 310 is configured to securely write an initialization command to the accelerator 136 to initialize a secure DMA transfer. The DMA manager 310 is further configured to securely configure a descriptor indicative of a host memory buffer, an accelerator 136 buffer, and a transfer direction. The transfer direction may be host to accelerator 136 or accelerator 136 to host. The DMA manager 310 is further configured to securely write a finalization command to the accelerator 136 to finalize an authentication tag (AT) for the secure DMA transfer. The initialization command, the descriptor, and the finalization command may each be securely written and/or configured with an MMIO write request. The DMA manager 310 may be further configured to determine whether to transfer additional data in response to securely configuring the descriptor, the finalization command may be securely written in response to determining that no additional data remains for transfer.

The AT controller 318 is configured to initialize an AT in response to the initialization command from the TEE 302. The AT controller 318 is further configured to finalize the AT in response to the finalization command from the TEE 302.

The DMA engine 320 is configured to transfer data between the host memory buffer and the accelerator 136 buffer in response to the descriptor from the TEE 302. For a transfer from host to accelerator 136, transferring the data includes copying encrypted data from the host memory buffer and forwarding the plaintext data to the accelerator 136 buffer in response to decrypting the encrypted data. For a transfer from accelerator 136 to host, transferring the data includes copying plaintext data from the accelerator 136 buffer and forwarding encrypted data to the host memory buffer in response encrypting the plaintext data.

The accelerator cryptographic engine 312 is configured to perform a cryptographic operation with the data in response to transferring the data and to update the AT in response to transferring the data. For a transfer from host to accelerator 136, performing the cryptographic operation includes decrypting encrypted data to generate plaintext data. For a transfer from accelerator 136 to host, performing the cryptographic operation includes encrypting plaintext data to generate encrypted data.

The host validator 308 is configured to determine an expected AT based on the secure DMA transfer, to read the AT from the accelerator 136 in response to securely writing the finalization command, and to determine whether the AT from the accelerator 136 matches the expected AT. The host validator 308 may be further configured to indicate success if the ATs match and to indicate failure if the ATs do not match.

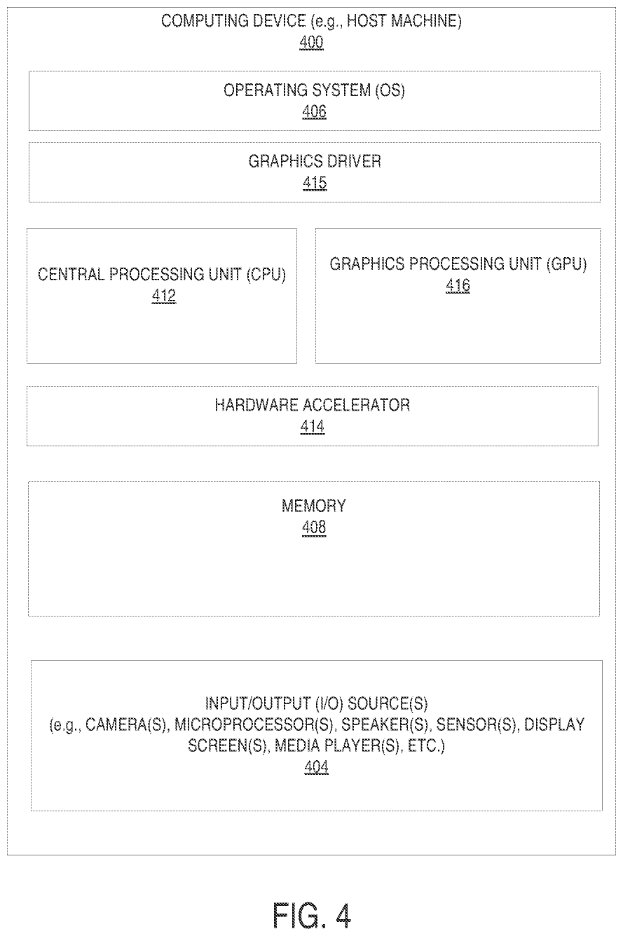

FIG. 4 illustrates another embodiment of a computing device 400. Computing device 400 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IOT) devices, laptop computers, desktop computers, server computers, set-top boxes (e.g., Internet based cable television set-top boxes, etc.), global positioning system (GPS) based devices, automotive infotainment devices, etc.

In some embodiments, computing device 400 includes or works with or is embedded in or facilitates any number and type of other smart devices, such as (without limitation) autonomous machines or artificially intelligent agents, such as a mechanical agents or machines, electronics agents or machines, virtual agents or machines, electromechanical agents or machines, etc. Examples of autonomous machines or artificially intelligent agents may include (without limitation) robots, autonomous vehicles (e.g., self-driving cars, self-flying planes, self-sailing boats, etc.), autonomous equipment self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 400 may include a computer platform hosting an integrated circuit (“IC”), such as a system on a chip (“SOC” or “SOC”), integrating various hardware and/or software components of computing device 400 on a single chip.

As illustrated, in one embodiment, computing device 400 may include any number and type of hardware and/or software components, such as (without limitation) graphics processing unit (“GPU” or simply “graphics processor”) 416, graphics driver (also referred to as “GPU driver”, “graphics driver logic”, “driver logic”, user-mode driver (UMD), user-mode driver framework (UMDF), or simply “driver ”) 415, central processing unit (“CPU” or simply “application processor”) 412, hardware accelerator 414 (such as an FPGA, ASIC, a re-purposed CPU, or a re-purposed GPU, for example), memory 408, network devices, drivers, or the like, as well as input/output (I/O) sources 404, such as touchscreens, touch panels, touch pads, virtual or regular keyboards, virtual or regular mice, ports, connectors, etc. Computing device 400 may include operating system (OS) 406 serving as an interface between hardware and/or physical resources of the computing device 400 and a user.

It is to be appreciated that a lesser or more equipped system than the example described above may be utilized for certain implementations. Therefore, the configuration of computing device 400 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, “element”, and “mechanism” may include, by way of example, software, hardware and/or a combination thereof, such as firmware.

Computing device 400 may host network interface device(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(s). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMS, EPROMS (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and / or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message” , and the like, may be used interchangeably throughout this document.

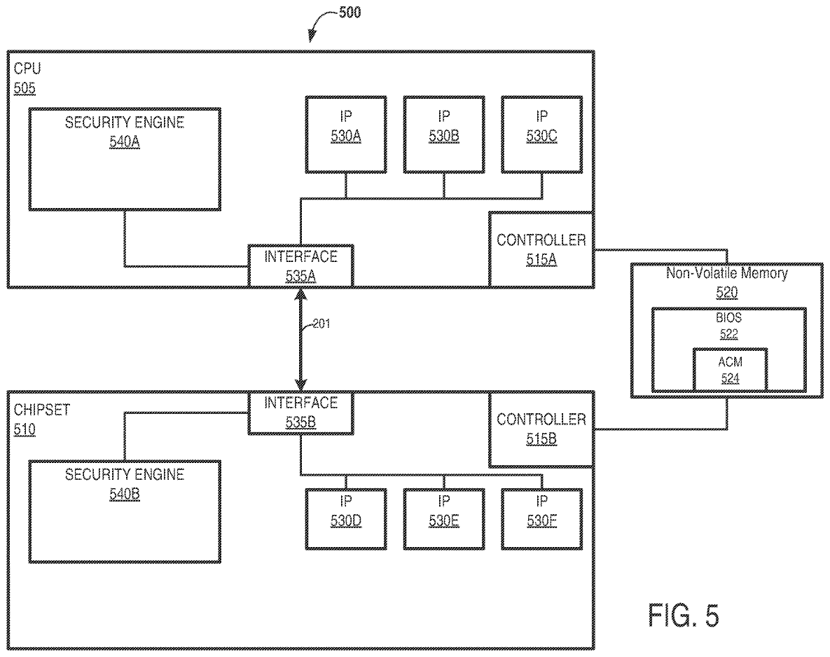

FIG. 5 illustrates one embodiment of a platform 200. As shown in FIG. 5, platform 500 includes CPU 505 and a chipset 510. In one embodiment, CPU 505 and chipset 510 are implemented on separate integrated circuit (IC) packages (or die). In a further embodiment, CPU 505 and chipset 510 each comprise an interface 535 (e.g., interfaces 535A and 535B) to facilitate communication. In such an embodiment, each interface comprises a link controller. In still a further embodiment, CPU 505 and chipset 510 communicate via a direct media interface (DMI) 501. However, in other embodiments, other types of interfaces (e.g., a flexible display interface (FDI)) may be implemented.

CPU 505 and a chipset 510 further include interconnect protocol (IP) agents 530 (e.g., IP agents 530A-530C within CPU 505 and IP agents 530D-530F within chipset 510). In such an embodiment, the interconnect protocol provides a standardized interface to enable CPU and chipset vendors, as well as third parties, to design logic such as IP agents to be incorporated in chipset 510. IP agents 530 may include general purpose processors (e.g., in-order or out-of-order cores), fixed function units, graphics processors, I/O controllers, display controllers, etc. In such an embodiment, each IP agent 530 includes a hardware interface to provide standardization to enable the IP agent 530 to communicate with other platform 500 components. For example, in an embodiment in which IP agent 530 is a third-party visual processing unit (VPU), interface 535 provides a standardization to enable the VPU to access a memory. Although discussed herein as a CPU and chipset, other embodiments may feature CPU 505 and chipset 510 as two system on chips (SOCs).

According to one embodiment, CPU 505 and chipset 510 each include a security engine 540 (e.g., 540A and 540B) to perform various security operations (e.g., security processing, cryptographic functions, etc.). In such an embodiment, each security engine 540 comprises a cryptographic processor that is implemented as a Trusted Platform Module (TPM) that operates as a root of trust (or platform RoT) to assure the integrity of hardware and software operating on platform 500. In a further embodiment, the RoT stores and reports measurements that are used for reporting and evaluating the current platform 500 configuration and for providing long-term protection of sensitive information. As used herein, a RoT is defined as a set of functions in a trusted computing module within a host that is always trusted by the host's operating system (OS). The RoT serves as separate compute engine controlling the trusted computing platform cryptographic processor, such as security engine 540, on platform 500.

In one embodiment, CPU 505 and chipset 510 include controller 515A and controller 515B, respectively, to access firmware stored in non-volatile memory 520. In such an embodiment, the non-volatile memory 520 firmware includes BIOS 522 that is used to provide runtime service for the OS and perform hardware initialization during the booting of platform 500. In a further embodiment, BIOS includes an authenticated code module (ACM) 524 that comprises code created and digitally signed with a private key that is only known to the CPU 505 manufacturer and invoked using a secure area within CPU 505 that is protected from external influence. In one embodiment, ACM 524 measures the system BIOS and performs several BIOS-based security functions. In a further embodiment, ACM 524 may also comprise a secure initialization (SINIT) ACM that is called by the OS or applications running under the OS 106 to perform a measured launch (e.g., DRTM).

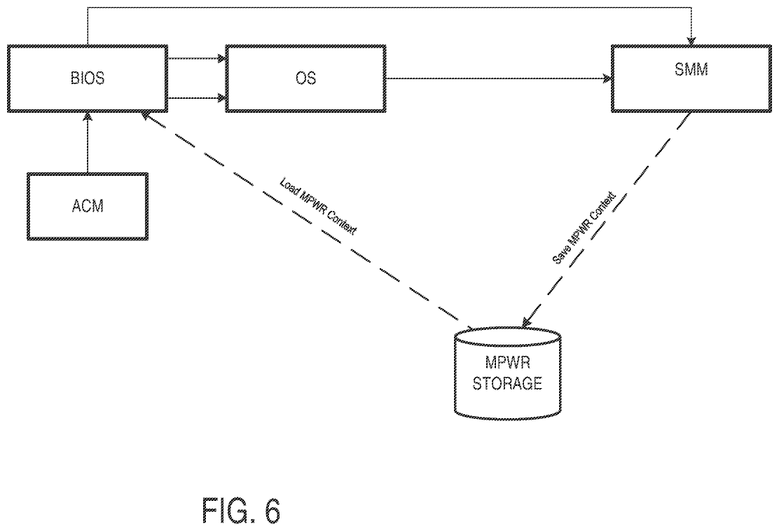

As discussed above, MPWR is implemented to preserve operating system (OS) memory and activate upgraded firmware during a platform reset. In conventional MPWR operation, the OS sets up a MPWR wakeup vector whenever it is to perform MPWR. After a warm reset (e.g., memory is in self-refresh), the BIOS will not access OS memory during platform initialization and jumps to the OS provided MPWR wakeup vector. FIG. 6 illustrates a conventional MPWR architecture.

In a normal boot process, BIOS triggers the boot via a system management mode (SMM) and saves the initial OS memory map to (e.g., System Management RAM (SMRAM)). Subsequently, BIOS performs the boot and passes the memory map to the OS. In a MPWR reset, the OS initiates a reset at the SMM via a system management interrupt (SMI), which forwards a MPWR entry point and preserves the OS memory map. Subsequently, the SMM saves a MPWR context (or process state) to storage (e.g., MPWR storage). Finally, the MPWR reset is triggered. In a MPWR boot, an ACM may be implemented to jump to the reset vector. Next, the MPWR context is loaded from the MPWR storage. BIOS then detects the MPWR mode and jumps to the MPWR entry point using the MPWR context. The above-described MPWR architecture is inadequate for current platform architectures in which the current trend is to move the non-volatile memory including the BIOS firmware from the platform because of the potential security issues attributed to BIOS provided by third party vendors.

According to one embodiment, MPWR Boot Shield logic is implemented to enforce a security policy in which BIOS may not access OS memory. In such an embodiment, platform 500 separates SMI handlers into Ring 3 and Ring 0 privilege levels. Supervisor/user paging on the Ring 0 portion enforces access policy for all of the ring 3 code with regard to the SMM state save, model-specific registers (MSR), input-output (IO) ports and other registers. The Ring 0 portion also performs save/restore of register context to allow the Ring 3 section to make use of those registers without having direct access to the OS context or the ability to modify the OS context. Further, Ring 0 is attested by the processor.

In one embodiment, the MPWR Boot Shield logic operates in ring 0 and thus permitted to configure memory type range register (MTRR), page table, Input-Output Memory Management Unit (IOMMU) table, and IO/memory-mapped I/O (MMIO) access control to ensure the OS memory cannot be tampered with by BIOS. In a further embodiment, the BIOS is deprivileged to ring 3 and can only perform limited system initialization without impacting OS memory. In yet a further embodiment, the MPWR Boot Shield logic is authenticated by ACM 524, which enables the MPWR Boot Shield logic establishes security policy enforcement and deprivileges the BIOS, thus preventing the BIOS from accessing OS memory in MPWR boot flow. MPWR SMM Shield logic 722 logic is also included to assist the MPWR context setup from the OS. In one embodiment, the MPWR SMM Shield is authorized by a SMM Policy Shim to ensure that an OS MPWR context is securely transferred to the MPWR Boot Shield during the reset.

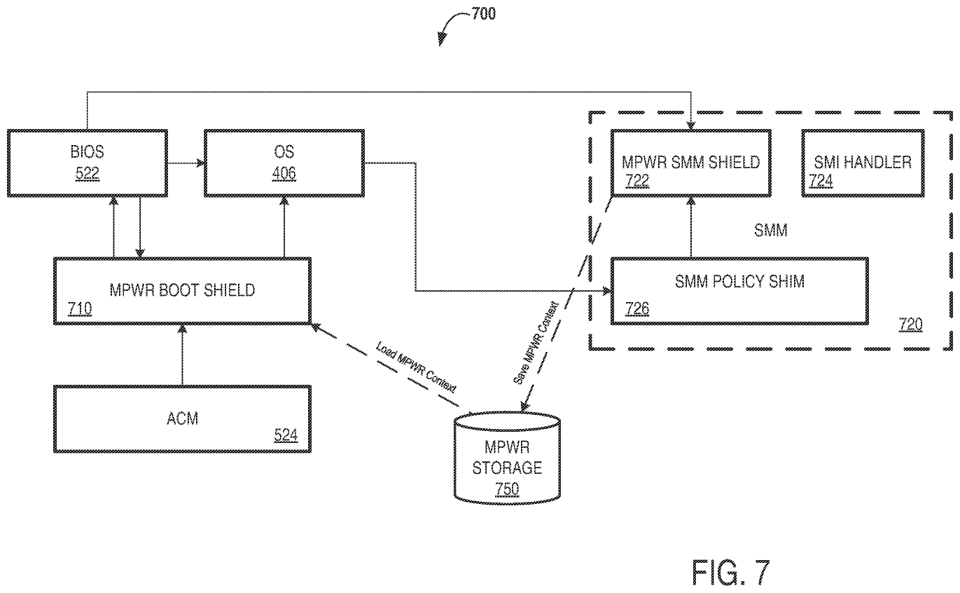

FIG. 7 illustrates one embodiment of a MPWR architecture 700 implementing MPWR Boot Shield logic 710. As shown in FIG. 7, MPWR Boot Shield logic 710 is communicatively coupled to BIOS 522, OS 406 and storage 750. In addition, SMM 720 is separated into MPWR SMM Shield logic 722, SMI handler 724 and SMM policy shim 726 components. In one embodiment, MPWR SMM Shield logic 722 comprises code created to operate as a ring 3 component that ensures that an MPWR context is securely transferred to the MPWR Boot Shield logic 710, which will be discussed in more detail below.

MPWR Boot Shield logic 710 comprises ring 0 code included as a security component within an initial boot block (IBB) in BIOS 522. In one embodiment, MPWR Boot Shield logic 710 is implemented to verify the integrity of BIOS 522, initialize memory, and load BIOS 522 into the system memory. In one embodiment, MPWR Boot Shield logic 710 controls the CPU reset vector. In a further embodiment, ACM 524 verifies the integrity of MPWR Boot Shield 710 and reports the verification to a TPM Platform Configuration Register (PCR) for attestation. Subsequently, ACM 524 transfers control to MPWR Boot Shield 710. MPWR Boot Shield 710 then performs the following actions to enforce the platform security policy: 1) deprivilege the BIOS 522 to ring 3; 2) setup CPU paging to prevent BIOS from accessing OS memory; 3) setup IOMMU paging to prevent devices from using DMA to access OS memory; 4) setup IO/MSR bitmap and MMIO trap to monitor the BIOS access the decoder register (e.g., sum-addressed decoder (SAD) and target address decoder (TAD) register); and 4) extend to the TPM (e.g., via platform configuration register (PCR) (not shown) to record the error) in case of any detected violation.

MPWR SMM Shield logic 722 is an SMM component that works with SMM Policy Shim 726. In one embodiment, SMM Policy Shim 726 comprises code executed by the CPU to enforce the access control policy in SMM ring 0. In such an embodiment, SMM Policy Shim 726 launches a special MPWR handler to perform OS context saving (e.g., MPWR entry point and OS memory map) upon receiving a MPWR request.

In a further embodiment, SMM Policy Shim 726 performs the following actions to enforce the platform security policy: 1) deprivilege the SMI handler 724 handler to ring 3; 2) setup SMM paging to prevent SMI handler 724 from accessing OS memory; 3) setup SMM paging to prevent SMI handler 724 from accessing SMM Policy Shim 726 and MPWR SMM Shield logic 722; and 4) grant the full memory access right to MPWR SMM Shield logic 722 (e.g., because MPWR SMM Shield logic 722 may need backup OS memory to a non-volatile disk storage, such as Non-Volatile Dual In-line Memory Module (NVDIMM) or Solid State Disk (SSD)). In one embodiment, the full solution need ensure that only an authorized entity can read data from or write data to the disk by using authentication, such as Hard Disk Drive (HDD) password or TCG OPAL password.

MPWR SMM Shield logic 722 performs the following actions to enforce the platform security policy: 1) save the memory configuration and decoder register data; and 2) setup secure MPWR NV storage 750 for MPWR OS context (e.g., MPWR entry point, MPWR indicator, and OS memory map). For example, a dedicate MPWR flash region which can only be accessed by MPWR handler and cannot be accessed by other third-party SMI handler. In one embodiment, the implementation may be a Replay-Protection Monotonic Counter (RPMC) flash, Replay Protected Memory Block (RPMB) flash, or normal Serial Peripheral Interface (SPI) flash accessed only by MPWR handler. In a further embodiment, MPWR SMM Shield logic 722 is loaded and verified by SMM Policy Shim 726 prior to execution. SMM Policy Shim 726 is attested by using a system security report.

For a MPWR reset, the OS 406 issues a reset to SMM Policy Shim 726 via a SMI, which forwards a MPWR entry point and preserves the OS memory map.

Subsequently, SMM Policy Shim 726 dispatches the reset to MPWR SMM Shield logic 722. MPWR SMM Shield logic 722 saves the MPWR context to storage 750. In one embodiment, storage 750 comprises a secure non-volatile storage (NVS) with integrity protection, which cannot be written to by third-party SMI handlers.

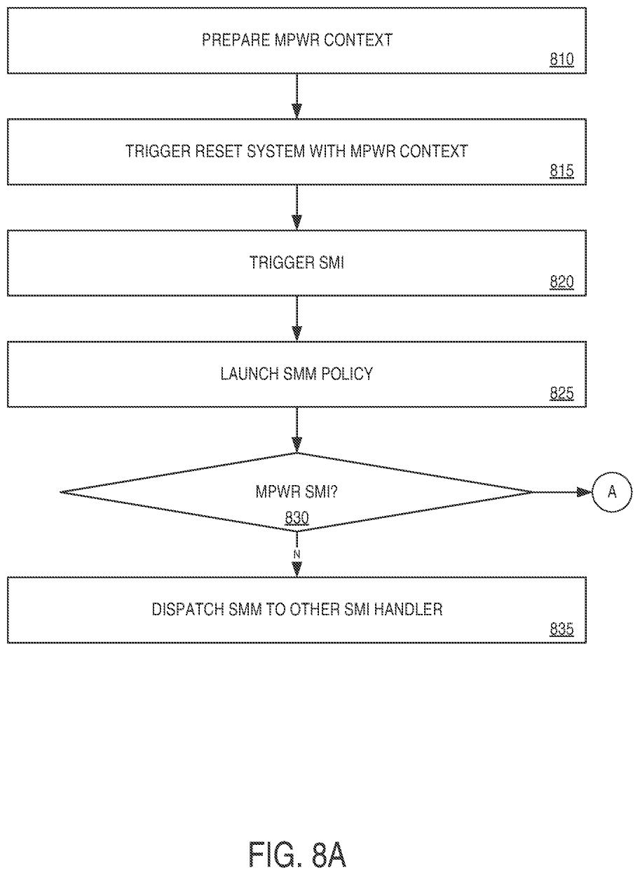

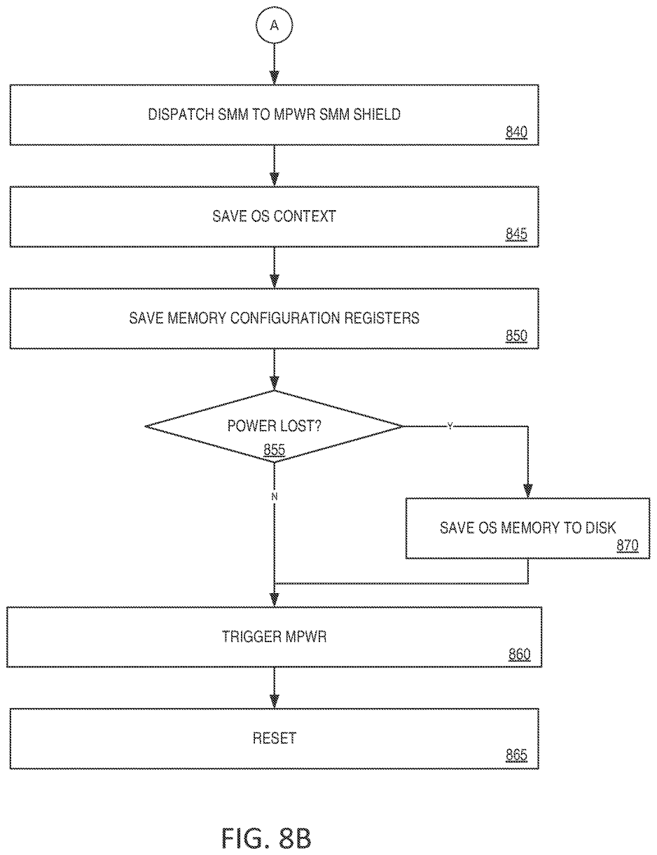

FIGS. 8A&8B is a flow diagram illustrating one embodiment of a MPWR reset process performed at OS runtime. At processing block 810 (FIG. 8A), OS 406 prepares the MPWR context (e.g., such as the MPWR entry point and OS memory map). At processing block 815, OS 406 triggers a ResetSystem runtime service provided by BIOS 522. At processing block 820, the BIOS 522 ResetSystem runtime service triggers a SMI. At processing block 825, control is transferred to SMM Policy Shim 726 once the SMI is delivered to the SMM entry point.

At decision block 830, SMM Policy Shim 726 determines whether the SMI comprises a MPWR SMI. If not, SMM Policy Shim 726 dispatches the SMI to a conventional SMI handler, processing block 835. Upon determining that the SMM comprises a MPWR SMI, SMM Policy Shim 726 dispatches the SMI to MPWR SMM Shield logic 722, processing block 840 (FIG. 8B). At processing block 845, MPWR SMM Shield logic 722 saves the MPWR context to MPWR storage 750.

At processing block 850, MPWR SMM Shield logic 722 saves the memory configuration and decoder register (e.g., SAD and TAD) to MPWR storage 750. In one embodiment, this process ensures that the registers may be properly configured, such as System Management RAM (SMRAM), TXT stolen memory, etc. At decision block 855, a determination is made as to whether power has been lost. If not, MPWR SMM Shield logic 722 triggers the MPWR reset, processing block 860. At processing block 865, the MPWR reset is performed. Upon a determination at decision block 855 that power has been lost, MPWR SMM Shield logic 722 saves the OS memory (e.g., to non-volatile memory), processing block 870, prior to triggering the MPWR reset.

In a MPWR boot, ACM 524 verifies the integrity of MPWR Boot Shield logic 710 prior to transferring control of MPWR Boot Shield logic 710. However, in other embodiments, the integrity of MPWR Boot Shield logic 710 may be verified by security engine 540. MPWR Boot Shield logic 710 then retrieves the MPWR context from storage 750. MPWR Boot Shield logic 710 uses the context to configure the MTRR, page table, IOMMU table, and IO/MMI, etc. Next, MPWR Boot Shield logic 710 transfers control to BIOS 522, which detects the MPWR mode. In response, BIOS 522 requests MPWR Boot Shield logic 710 to transfer control to OS 406, Subsequently, OS 406 jumps to the OS 406 entry point.

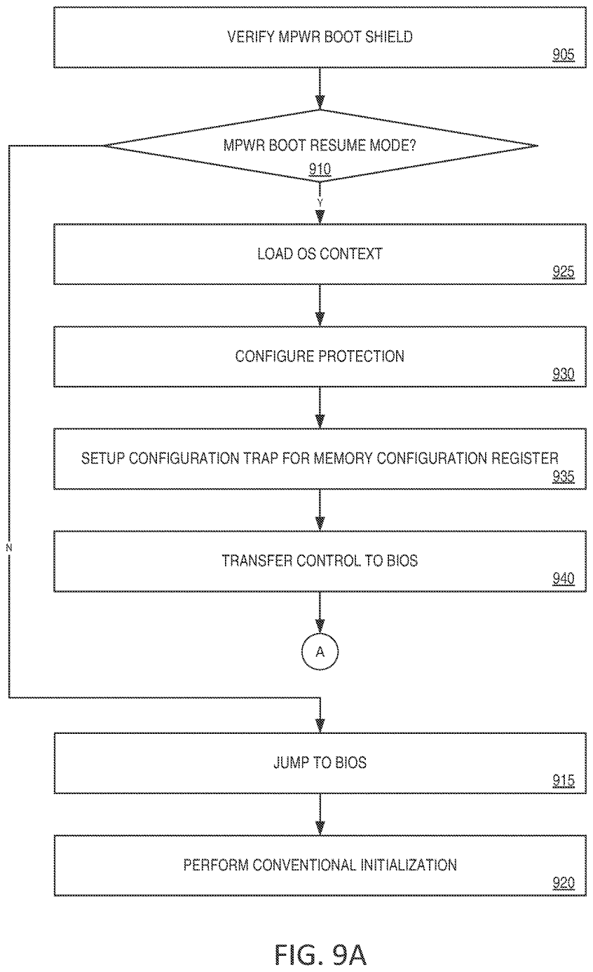

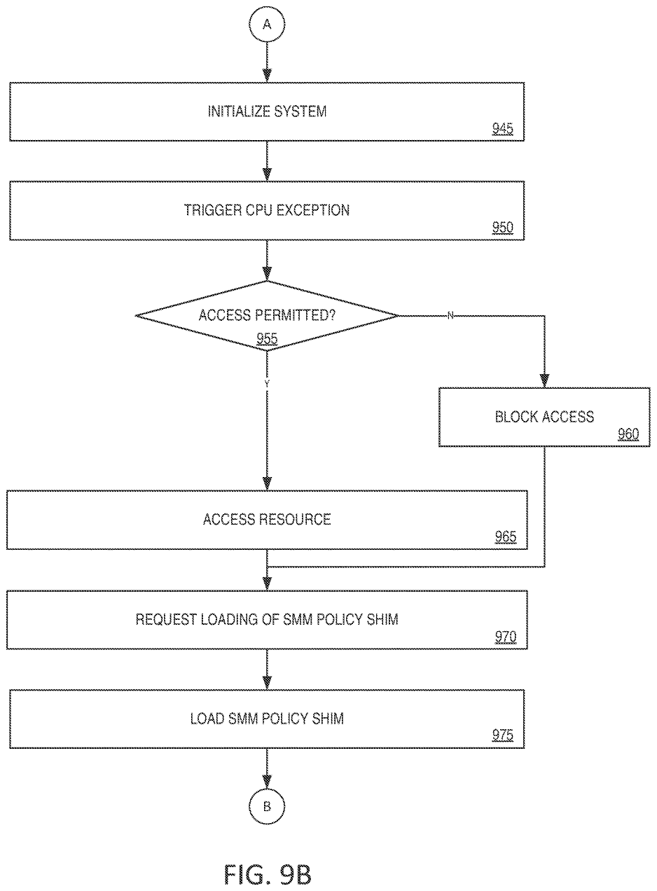

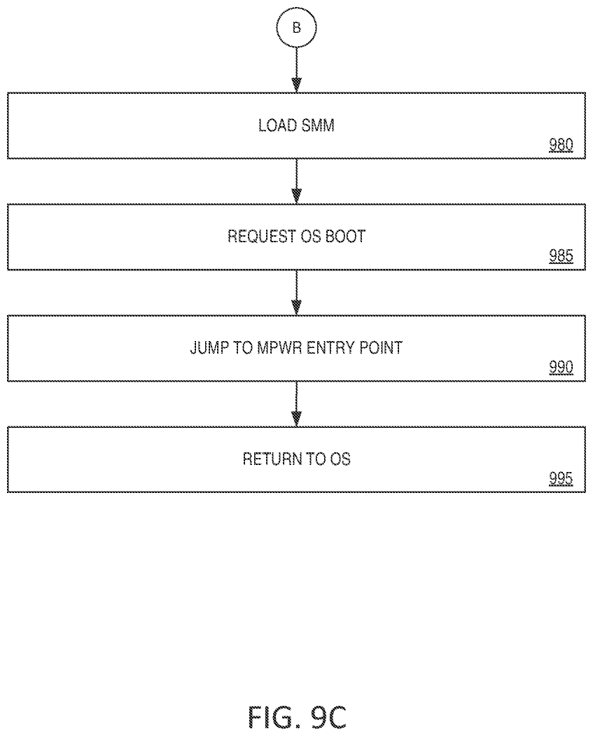

FIGS. 9A-9B is a flow diagram illustrating one embodiment of a MPWR boot process to resume OS 406. At processing block 905 (FIG. 9A), the integrity of MPWR Boot Shield logic 710 is verified. As discussed above, the integrity of MPWR Boot Shield logic 710 may be verified by ACM 524 or directly via security engine 540. In one embodiment, the boot process stops upon a determination that the MPWR Boot Shield logic 710 fails. In such an embodiment, control is forwarded to the CPU 505 vector, which is controlled by MPWR Boot Shield logic 710.

At decision block 910, MPWR Boot Shield logic 710 determines whether the platform is in a MPWR resume boot mode. If not, MPWR Boot Shield logic 710 transfers control to BIOS 522 operating in the ring 0 privilege level, processing block 915. At processing block 920, BIOS 522 performs a conventional initialization process. Upon a determination at decision block 910 that the platform is in the MPWR resume boot mode, MPWR Boot Shield logic 710 loads the OS context from storage, processing block 925. As a result, MPWR Boot Shield logic 710 may access the OS MPWR memory map.

At processing block 930, MPWR Boot Shield logic 710 configures CPU paging and IOMMU protection according to the OS MPWR memory map. In one embodiment, OS regions are marked as not present in the CPU page table or IOMMU configuration. At processing block 935, MPWR Boot Shield logic 710 loads the expected memory configuration and decoder register value from MPWR storage 750, and configures IO/MSR/MMIO configuration trap for the registers (e.g., especially for those impacting the memory configuration or decoder, such as SAD and TAD). This process ensures that BIOS 522 will not misconfigure those registers to attack the system.

At processing block 940, MPWR Boot Shield logic 710 transfers control to BIOS 522. In one embodiment, MPWR Boot Shield logic 710 configures the interrupt handler to handle potential exceptions from BIOS 522. Thus, once the protection is configured, MPWR Boot Shield logic 710 switches to ring-3 and jumps to the BIOS 522 entry point. At processing block 945 (FIG. 9B), BIOS 522 initializes the system in the ring-3 context in MPWR boot mode. At processing block 950, BIOS 522 triggers a CPU exception (e.g., General Purpose Exception in MSR or IO access, or Page Fault Exception in MMIO access) during the system initialization. For example, BIOS 522 may attempt to program silicon registers that are monitored by the MPWR Boot Shield 722. In such an embodiment, the MPWR Boot Shield logic 710 may force the BIOS 522 to always perform the same configuration as the loaded memory configuration and decoder register value from MPWR storage 750. In an alternative embodiment, MPWR Boot Shield logic 710 provides a one-time service to program those registers. As such, BIOS 522 may call this special service for memory configuration.

At decision block 955, an interrupt handler within MPWR Boot Shield logic 710 determines whether the resource access is permitted. For example, accessing any OS memory is illegal should be forbidden, while accessing the silicon register may be supported if the data is valid. Upon a determination that access is not permitted, processing block 960. In case of an access violation, MPWR Boot Shield logic 710 flags the TPM with an error record that is used to inform OS 406. Additionally, MPWR Boot Shield logic 710 may use a pre-define policy to determine the next step (e.g., continue booting the system or reset the system to abort MPWR mode).

After access has been blocked, or upon a determination at decision block 955 that the access request is permitted, MPWR Boot Shield logic 710 accesses the resource on behalf of BIOS 522 and returns the result back to BIOS 522, processing block 965. At processing block 970, BIOS 522 continues the initialization in ring 3. In one embodiment, BIOS 522 may request MPWR Boot Shield logic 710 to load SMM Policy Shim 726 upon a determination that BIOS 522 needs to setup the SMM environment. At processing block 975, MPWR Boot Shield logic 710 loads SMM Policy Shim 726 to SMRAM and the SMM Policy Shim 726 setup protection policy based upon the MPWR context (e.g., OS memory map). In one embodiment, SMM Policy Shim 726 also loads MPWR SMM Shield 722.

At processing block 980 (FIG. 9C), BIOS 522 loads the remaining SMM modules. At processing block 985, BIOS 522 requests MPWR Boot Shield logic 710 to return to the OS MPWR entry point (e.g., by using a system call). At processing block 990, MPWR Boot Shield logic 710 retrieves the MPWR entry point from the OS MPWR context. Subsequently, MPWR Boot Shield logic 710 resets the protection environment to transfer control back to OS 406 (e.g., grant OS memory access right in the page table, block all device DMA in IOMMU engine). At processing block 995, MPWR Boot Shield logic 710 jumps to the OS MPWR entry point. In one embodiment, the OS MPWR entry point takes control of the platform, immediately sets up new global descriptor table (GDT), Interrupt Descriptor Table (IDT), page table, and restores the OS environment.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising one or more processors to receive a request to trigger a system management interrupt (SMI), execute policy shim code to enforce access control policy in a first privilege level and dispatch the SMI to shield code to enforce the access security policy to perform a system management mode (SMM) and execute the shield code to perform the SMM, including retrieving an operating system (OS) memory preserved warm reset (MPWR) context, saving the MPWR context and issuing a warm reset.

Example 2 includes the subject matter of Example 1, wherein the one or more processors further execute the shield code to save a memory configuration.

Example 3 includes the subject matter of Examples 1 and 2, wherein the MPWR context and the memory configuration are saved to a MPWR non-volatile memory.

Example 4 includes the subject matter of Examples 1-3, wherein the one or more processors further execute the shield code to save OS memory.

Example 5 includes the subject matter of Examples 1-4, wherein the one or more processors further execute the policy shim code to determine whether the SMI comprises a MPWR SMI.

Example 6 includes the subject matter of Examples 1-5, wherein the one or more processors further execute the policy shim code to dispatch the SMI to a SMI handler upon determining that the SMI is not a MPWR SMI.

Some embodiments pertain to Example 7 that includes an apparatus comprising one or more processors to execute boot shield code to enforce access control policy in a first privilege level, load memory preserved warm reset (MPWR) context, retrieve an operating system (OS) MPWR entry point from the MPWR context; and execute the OS to resume operation of a computing platform at the OS MPWR entry point.

Example 8 includes the subject matter of Example 7, wherein the one or more processors further execute the boot shield code to configure processor paging and Input-Output Memory Management Unit (IOMMU) protection.

Example 9 includes the subject matter of Examples 7 and 8, wherein the one or more processors further execute the boot shield code to configure a memory configuration register.

Example 10 includes the subject matter of Examples 7-9, wherein the one or more processors further execute the boot shield code to deprivilege a basic input/output system (BIOS) to a second privilege level.

Example 11 includes the subject matter of Examples 7-10, wherein the one or more processors further execute the BIOS to initialize the computing platform.

Example 12 includes the subject matter of Examples 7-11, wherein the one or more processors further execute the boot shield code to determine whether the BIOS is permitted access to one or more computing platform resources.

Example 13 includes the subject matter of Examples 7-12, wherein the one or more processors further execute the boot shield code to access the one or more computing platform resources on behalf of the BIOS and return results the BIOS.

Example 14 includes the subject matter of Examples 7-13, wherein the one or more processors further execute authenticated code to verify integrity of the boot shield code.

Some embodiments pertain to Example 15 that includes a method comprising triggering a system management interrupt (SMI), performing a policy operation to enforce access control policy in a first privilege level, dispatching the SMI to a shield operation to enforce the access security policy to perform a system management mode (SMM), performing the shield operation to perform the SMM, including retrieving an operating system (OS) memory preserved warm reset (MPWR) context, saving the MPWR context and issuing a warm reset.

Example 16 includes the subject matter of Example 15, wherein performing the shield operation further comprises saving a memory configuration.

Example 17 includes the subject matter of Examples 15 and 16, wherein performing the shield operation further comprises to save OS memory.

Example 18 includes the subject matter of Examples 15-17, wherein performing the policy operation comprises determining whether the SMI comprises a MPWR SMI and dispatching the SMI to a SMI handler upon determining that the SMI is not a MPWR SMI.

Some embodiments pertain to Example 19 that includes at least one computer readable medium having instructions stored thereon, which when executed by one or more processors, cause the processors to perform a boot shield operation to enforce access control policy in a first privilege level, load memory preserved warm reset (MPWR) context, retrieve an operating system (OS) MPWR entry point from the MPWR context and resume operation of a computing platform at the OS MPWR entry point.

Example 20 includes the subject matter of Example 19, having instructions stored thereon, which when executed by one or more processors, further cause the processors to perform the boot shield operation to configure processor paging and Input-Output Memory Management Unit (IOMMU) protection and configure a memory configuration register.

Example 21 includes the subject matter of Examples 19 and 20, having instructions stored thereon, which when executed by one or more processors, further cause the processors perform a process to perform the boot shield operation to deprivilege a basic input/output system (BIOS) to a second privilege level.

The embodiments have been described above with reference to specific embodiments. Persons skilled in the art, however, will understand that various modifications and changes may be made thereto without departing from the broader spirit and scope of the embodiment as set forth in the appended claims. The foregoing description and drawings are, accordingly, to be regarded in an illustrative rather than a restrictive sense.

1-22. (canceled)

23. An apparatus comprising:
one or more processors to:
trigger a system management interrupt (SMI);
execute policy shim code to enforce access control policy in a first privilege level and dispatch the SMI to shield code to enforce an access security policy to perform a system management mode (SMM); and
execute the shield code to perform the SMM, including:
retrieving an operating system (OS) memory preserved warm reset (MPWR) context;
saving the MPWR context; and
issuing a warm reset.

24. The apparatus of claim 23, wherein the one or more processors further execute the shield code to save a memory configuration.

25. The apparatus of claim 24, wherein the MPWR context and the memory configuration are saved to a MPWR non-volatile memory.

26. The apparatus of claim 25, wherein the one or more processors further execute the shield code to save OS memory.

27. The apparatus of claim 23, wherein the one or more processors further execute the policy shim code to determine whether the SMI comprises a MPWR SMI.

28. The apparatus of claim 27, wherein the one or more processors further execute the policy shim code to dispatch the SMI to a SMI handler upon determining that the SMI is not the MPWR SMI.

29. An apparatus comprising:
one or more processors to:
execute boot shield code to enforce access control policy in a first privilege level, load memory preserved warm reset (MPWR) context, retrieve an operating system (OS) MPWR entry point from the MPWR context; and
execute the OS to resume operation of a computing platform at the OS MPWR entry point.

30. The apparatus of claim 29, wherein the one or more processors further execute the boot shield code to configure processor paging and Input-Output Memory Management Unit (IOMMU) protection.

31. The apparatus of claim 30, wherein the one or more processors further execute the boot shield code to configure a memory configuration register.

32. The apparatus of claim 31, wherein the one or more processors further execute the boot shield code to deprivilege a basic input/output system (BIOS) to a second privilege level.

33. The apparatus of claim 32, wherein the one or more processors further execute the BIOS to initialize the computing platform.

34. The apparatus of claim 33, wherein the one or more processors further execute the boot shield code to determine whether the BIOS is permitted access to one or more computing platform resources.

35. The apparatus of claim 34, wherein the one or more processors further execute the boot shield code to access the one or more computing platform resources on behalf of the BIOS and return results the BIOS.

36. The apparatus of claim 29, wherein the one or more processors further execute authenticated code to verify integrity of the boot shield code.

37. A method comprising:
triggering a system management interrupt (SMI);
performing a policy operation to enforce access control policy in a first privilege level;
dispatching the SMI to a shield operation to enforce the access security policy to perform a system management mode (SMM); and
performing the shield operation to perform the SMM, including:
retrieving an operating system (OS) memory preserved warm reset (MPWR) context;
saving the MPWR context; and
issuing a warm reset.

38. The method of claim 37, wherein performing the shield operation further comprises saving a memory configuration.

39. The method of claim 38, wherein performing the shield operation further comprises to save OS memory.

40. The method of claim 37, wherein performing the policy operation comprises determining whether the SMI comprises a MPWR SMI and dispatching the SMI to a SMI handler upon determining that the SMI is not a MPWR SMI.

41. The method of claim 37, further comprising determining whether the SMI comprises a MPWR SMI.

42. The method of claim 41, further comprising dispatching the SMI to a SMI handler upon determining that the SMI is not the MPWR SMI.
